(19) United States
(12) Patent Application Publication
(10) Pub. No.: US 2017/0024791 A1
(43) Pub. Date: Jan. 26, 2017

(54) SYSTEM AND METHOD FOR INTERACTIVE METADATA AND INTELLIGENT PROPAGATION FOR ELECTRONIC MULTIMEDIA

(71) Applicant: Theresa Klinger, Alamo, CA (US)

(72) Inventor: Theresa Klinger, Alamo, CA (US)

(21) Appl. No.: 15/146,719

(22) Filed: May 4, 2016

Related U.S. Application Data
(63) Continuation-in-part of application No. 14/919,658, filed on Oct. 21, 2015, now abandoned.
Application No. 14/919,658 is a continuation of application No. 11/968,384, filed on Jan. 2, 2008, now abandoned.
Application No. 11/968,384 is a continuation-in-part of application No. 14/948,239, filed on Nov. 20, 2015, now abandoned.
Application No. 14/948,239 is a continuation of application No. 12/023,492, filed on Jan. 31, 2008, now abandoned.
Application No. 12/023,492 is a continuation-in-part of application No. 11/968,374, filed on Jan. 2, 2008, now abandoned.
(60) Provisional application No. 60/989,430, filed on Nov. 20, 2007.
(60) Provisional application No. 61/013,548, filed on Dec. 13, 2007.
(60) Provisional application No. 60/989,425, filed on Nov. 20, 2007.

(51) Int. Cl. G06Q 30/06; G06F 17/30; H04L 29/08

(52) U.S. Cl. CPC G06Q 30/0623; H04L 67/2804; G06F 17/30864; H04L 67/42

(57) ABSTRACT

A system that associates metadata to a clickable component and with an object that appears in an electronic media file. The clickable component is a visual indicium that binds and associated metadata related to an item in the media. User devices may activate the clickable component via a pointing device or touchscreen device. Activation of the clickable component may cause a request for additional information, an invitation to share the metadata, a communication to embedded contact information within the metadata, and may transport at least a portion of the metadata to a destination.

### CROSS-REFERENCE TO RELATED APPLICATIONS

The present application is a continuation-in-part of U.S. patent application Ser. No. 14/919,658, titled “METHOD AND SYSTEM FOR LINKING ePROCUREMENT TO VIRTUAL COMMUNITIES”, filed on Oct. 21, 2015, which is a continuation of U.S. patent application Ser. No. 11/968,384, titled “METHOD AND SYSTEM FOR LINKING ePROCUREMENT TO VIRTUAL COMMUNITIES”, filed on Jan. 2, 2008, which claims priority to U.S. provisional application Ser. No. 60/989,430, titled “METHOD AND SYSTEM FOR COMBINING ePROCUREMENT AND SOCIAL NETWORKS”, filed on Nov. 20, 2007, the specifications of each of which are hereby incorporated by reference in their entirety. The present application is also a continuation-in-part of U.S. patent application Ser. No. 14/948,239, titled “METHOD AND SYSTEM FOR MONETIZING USER-GENERATED CONTENT”, filed on Nov. 20, 2015, which is a continuation of U.S. patent application Ser. No. 12/023,492, titled “METHOD AND SYSTEM FOR MONETIZING USER-GENERATED CONTENT” and filed on Jan. 31, 2008, which is a continuation-in-part of U.S. application Ser. No. 11/968,374, titled “METHOD AND SYSTEM FOR MONETIZING USER-GENERATED CONTENT” and filed on Jan. 2, 2008, which claims the benefit of U.S. provisional application Ser. No. 61/013,548, titled “METHOD AND SYSTEM FOR MONETIZING USER-GENERATED CONTENT” and filed Dec. 13, 2007, and to U.S. provisional application Ser. No. 60/989,425, titled “METHOD AND SYSTEM FOR MONETIZING USER GENERATED CONTENT” and filed on Nov. 20, 2007, the entire specifications of each of which are incorporated herein by reference in their entirety.

### BACKGROUND OF THE INVENTION

Field of the Art

The disclosure relates to the field of digital media, and more particularly to the field of embedded metadata with digital media content.

Discussion of the State of the Art

In the field of digital media, metadata is often associated with content, generally an image or video segment, to identify content-related details that may not be a part of the image or video, such as creator information, file details, or other non-media information. This metadata generally relates directly to the media content itself and has no relevance outside the scope of a particular media file or segment.

What is needed is a means to generate and associate custom metadata tags with media content, present these tags to a user in an interactive context, and intelligently propagate metadata to a destination upon interaction.

### SUMMARY OF THE INVENTION

Accordingly, the inventor has conceived and reduced to practice, in a preferred embodiment of the invention, a system and method for interactive metadata and intelligent propagation for electronic multimedia.

According to a preferred embodiment of the invention, a system and method for creating an interactive metadata tag within media is disclosed. In a preferred embodiment of the invention, a method for creating an interactive metadata tag within media comprises deploying a network-connected electronic interactive metadata computer comprising at least a memory and a processor and further comprising programmable instructions stored in the memory and operating on the processor, where the instructions are configured to assigning interactive metadata within media such as electronic images or video. A creation engine receives electronic media from a plurality of network connected user devices and metadata associated to the media. A user device may request to configure a metadata tag within the image at a set of coordinates within the media. A visual tag may be then configured with a plurality of attributes for the visual tag to allow user-device to engage the tag to access the metadata and use the metadata within communication to purchasing systems, customer service, technical support and the like, assigning a unique identifier to the image and the metadata;

In a preferred embodiment of the invention, a system for interactive metadata and intelligent propagation for electronic multimedia comprises a network-connected interactive metadata computer comprising at least a memory and a processor and further comprises programmable instructions stored in the memory and operating on the processor, the programmable instruction configured to interact and propagate interactive metadata. Disclosed is a creation engine for creating interactive metadata tags and clickable components utilizing interactive metadata for presentation to a plurality of network-connected user devices through visual indicia at preconfigured coordinates within media; an account manager to manage a plurality of user device profile information for the plurality of user devices; a web server to present interactive metadata tags and clickable components the plurality of network-connected user devices accessible via a web browser; an app server to present interactive metadata tags and clickable components the plurality of network-connected user devices accessible via a special purpose application computer; a messaging gateway to request communication with the plurality of network-connected user devices and a plurality of external communication services; and, a metadata storage database to store and provide metadata content and associations.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary system architecture for interactive metadata and intelligent propagation for electronic multimedia, according to a preferred embodiment of the invention.

FIG. 2 is a flow diagram illustrating an exemplary method for creating interactive metadata tags and associating with electronic multimedia, according to a preferred embodiment of the invention.

FIG. 3 is an illustration of an exemplary user interface displaying media content with interactive metadata tags.

FIG. 4 is a block diagram illustrating an exemplary hardware architecture of a computing device used in an embodiment of the invention.

FIG. 5 is a block diagram illustrating an exemplary logical architecture for a client device, according to an embodiment of the invention.

FIG. 6 is a block diagram showing an exemplary architectural arrangement of clients, servers, and external services, according to an embodiment of the invention.

FIG. 7 is another block diagram illustrating an exemplary hardware architecture of a computing device used in various embodiments of the invention.

### DETAILED DESCRIPTION

The inventor has conceived, and reduced to practice, in a preferred embodiment of the invention, a system and method for interactive metadata and intelligent propagation for electronic multimedia.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

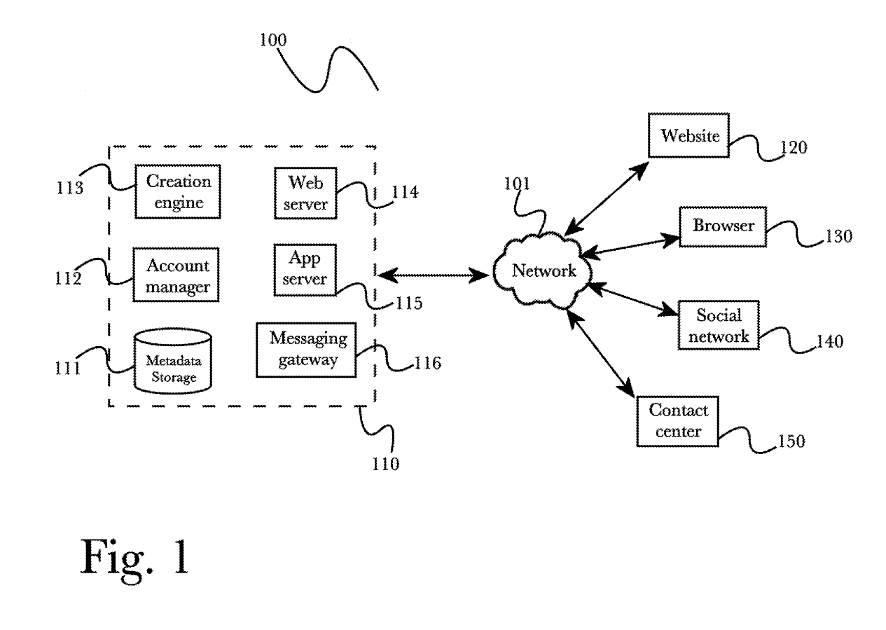

FIG. 1 is a block diagram illustrating an exemplary system architecture 100 for interactive metadata and intelligent propagation for electronic multimedia, according to a preferred embodiment of the invention. According to the embodiment, an interactive metadata system 110 may comprise metadata storage 111 comprising any of a variety of hardware storage or software-based database schema, that may be configured to store and provide metadata content and associations on demand to other system components during operation (for example, to store and provide specific metadata and information identifying its associations with media content, such as particular image files or video segments). Metadata information may comprise any of a variety of information content, for example contact information for an individual or a contact center (for example, as may be used to identify a content creator or a technical support contact), a web address such as for an e-commerce storefront, product or an information page, information about an associated product (such as a plurality of images of the product, cost information about the product, and the like), or other information. In some embodiments, a metadata object holds information pertaining to a plurality of descriptive text, images and other descriptors to an associated system element, for example, to the product, a vendor, a particular team within a vendor, etc. Account manager 112 may be used to manage user account information, for example including (and not limited to) contact information for a registered user (for example, a user who has registered an account with a company or website operating system 110), linked account information, such as a social network account login or account information for an online vendor's web storefront, create and manage profiles for vendor users, consumer users, users who share products, etc. This account information may be associated with vendor users, consumer users, products configured within the system, and/or used by interactive metadata components, as described below in greater detail.

Creation engine 113 may operate an interactive interface facilitating the creation of interactive metadata tags and clickable components utilizing interactive metadata for presentation to a user through media (for example, via an image or video), as well as their modification, association, deletion, or other administrative operations. Interactive metadata may comprise any of a variety of metadata content from a metadata storage 111, and may also utilize a user's account information provided by an account manager 112, to form complex metadata content and associations that may be used in a variety of functional contexts as clickable components presented to a user. It should also be appreciated that user account information may comprise information pertaining to a metadata creator, provider or administrator (for example, to provide contact information for the creator, provider, or administrator of a clickable component), or information pertaining to a viewing user (for example, so that a user may interact with a clickable component and implicitly supply their own information such as contact or login information).

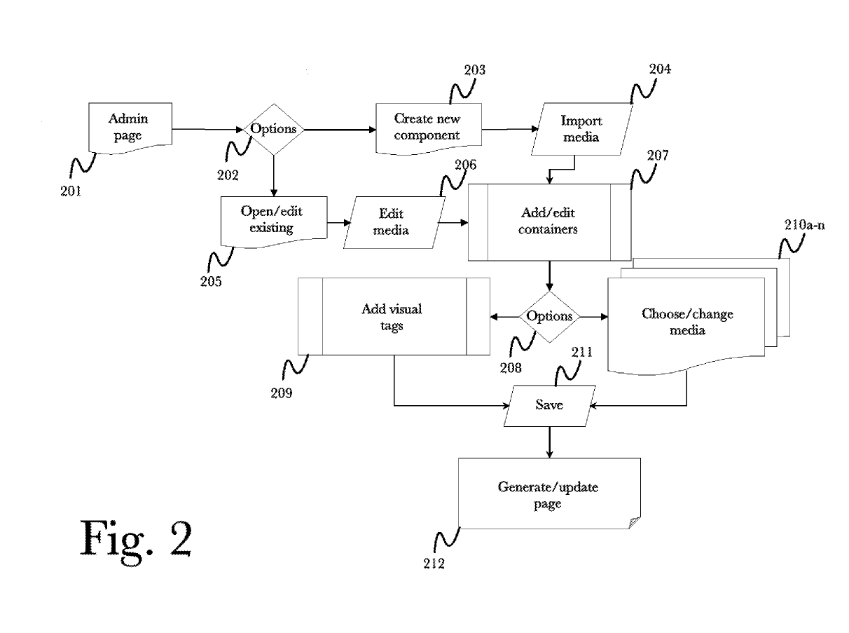

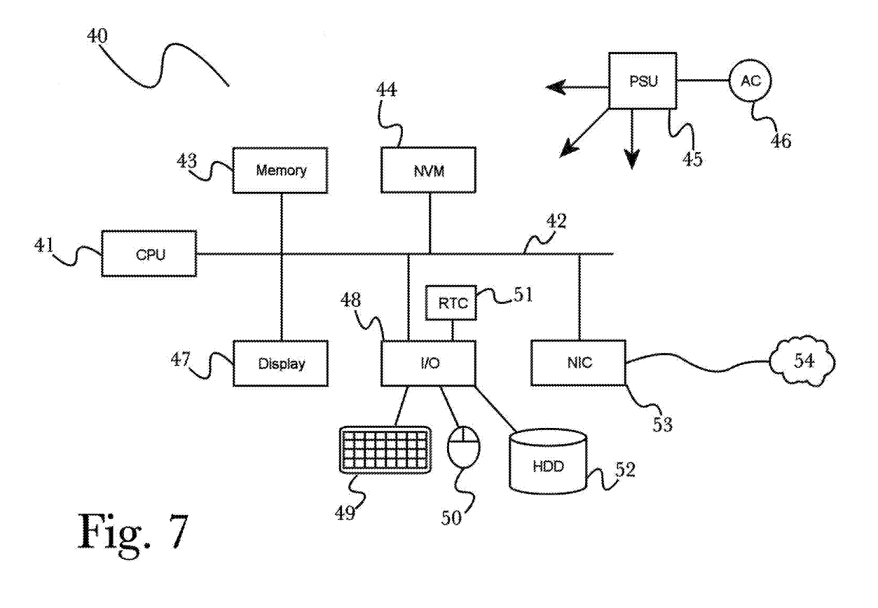

Interactive metadata may be presented to users as clickable components displayed in a network-connected web and/or application interface, via, for example, a web server 114 (in the case of clickable components presented in a web interface, such as in a browser window) or an application server 115 (in the case of a software application displaying clickable components, for example an image viewer, a browser, or other application). For example, a user browsing network 101 (for example, the Internet) via web browser application 130 may view media content such as images or video segments within a webpage. These images or video segments may have clickable components presented as visual elements overlaid upon the media content, for example to provide some indication to the user as to their function or content. For example, a clickable component associated with metadata describing a person may be overlaid upon that person's face within an image, or a clickable component for support with a product may be overlaid upon that product's image in a tech support forum or online storefront. It can be appreciated by one with ordinary skill in the art that several techniques can be used to overlay visual elements/clickable components upon the media content, for example, by using custom style sheet (CSS) and hyper-text markup language 5 (HTML 5) for presenting visual elements on display 47 (referring to FIG. 7). A user may then “hover” with, for example, a mouse cursor to view additional information to an associated entity associated to a particular clickable component (if enabled, “info on hover” may be utilized optionally during a clickable component creation process, as described below with reference to FIG. 2), or may “click” on a clickable component (or tap with their finger on a touchscreen, or other forms of computer interaction) to register an interaction and trigger the action associated with the clickable component. For example, a clickable component for support with a product may display detailed product information on hover (for example, specifications for a computer to ensure the use is viewing the appropriate model or variant, additional images giving a close-up view or different visual perspectives, cost information, specifications, etc.), and when clicked may present a set of clickable options as a visual graphic overlay such as direct the user to a tech support chat interface to get immediate assistance with the product, optionally while forwarding product and user information to the tech support agent to further expedite the support process, a checkout option to purchase, description information, or other options. Information to populate the visual graphic overlay may come directly (or indirectly) from associated metadata. A messaging gateway 116 may be used to provide for interaction with external services such as chat or other interaction methods operated by, for example, contact center 150. In this regard, interactive metadata may be provided via messaging gateway 116 to external services, performing any necessary translation or “wrapping” of information to ensure proper formatting or compatibility with a particular destination service, so that a contact center 150 or other destination may receive metadata contents via existing systems and means without needing to adapt their operation to accommodate the operation of system 110. For example, associated metadata may be transported via data embedded within a SIP/VoIP message payload, via a data structure attached to a third-party call control system, via a specially programmed communication client, or via some other messaging protocol.

Clickable components may also be presented within content displayed on an online social network 140, for example overlaid on images or videos uploaded by users or in advertisements displayed within a social networking interface. For example, a user may upload content to their social network page or profile, and then create a plurality of clickable components and associate them with the media for presentation to other users, such as to provide information on items within the media, contact info for other individuals in an image (such as their profiles within the social network), or other information. Interactive metadata may also be sent to a social network 140 as a destination for propagation, regardless of how a clickable component was viewed (for example, a component viewed in a web browser 130 may provide metadata to a social network 140). For example, a user may view media in a webpage with a clickable component on a product they like, such as an article of clothing being worn by a person in an image. Upon interaction with a clickable component associated with that product, the user may be directed to a “share this” interface or webpage, wherein they may choose to post content of their own (such as a text post, for example in a blog entry or similar social networking service) and metadata pertaining to the product may be propagated to the social network for inclusion in the content posting, for example to enable an easy mechanism for a user to share content they like, without having to manually re-enter the content details or provide their own images or description. Additionally, metadata may be propagated for inclusion as metadata within the destination content, such as to provide a link to a storefront where the product may be purchased, or contact information for the product creator or support, optionally as pre-constructed clickable components that the user may immediately associate with their new content. This data propagation operation may be configured during clickable component creation, as described below in greater detail (referring to FIG. 2). In this manner, media and metadata may be propagated easily while retaining relevant details with minimal effort from an end-user. In some embodiments, metadata may include actionable elements and information, for example, when a “share this” is offered, an instant discount may be offered if a product is shared. In other embodiments, metadata may include statistics pertaining to metadata objects, for example, including but not limited to, counters that may track the number of users clicking, using, or “liking” a metadata object or clickable component, or statistics pertaining to content associated with or incorporating a metadata object or clickable components, for example a count of how many times an item has been posted, sold, or configured with a clickable component (for example, where a clickable component overlaid onto an image in a product listing within an electronic storefront or within user-generated content such as a blog) or comment data from other users that have used or interacted with a metadata object or clickable component. For example, a clickable component on a photograph of a user's home interior posted on their social network page (for example, in a blog post) may be used to collect metadata regarding comments from other users left on the social network page, such as feedback regarding the item's use or arrangement, or combinations with other items in the photograph. This metadata may then be presented to users in the future when viewing or using the metadata object or clickable component, for example to provide them with additional insights into user behavior and response.

In some arrangements, users may setup a virtual catalog (or collection) of items for informational purposes (such as creating a catalog of variations of collectible items) or to establish a virtual storefront for purchasing displayed items, incorporating clickable components with associated metadata objects within item listings. Media and metadata objects may optionally be of the user's own creation (such as photographs taken of items they possess, or metadata provided manually when creating a clickable component for use), or may be selected for use from existing media and metadata (such as incorporating stock photographs of items, existing or pre-composed metadata objects, preconfigured clickable components, links to existing vendor pages such as a manufacturer or reseller's item listing, or other such uses). The user may thereby incorporate external content from other vendors (for example, from a large established virtual marketplace such as AMAZON™), presenting content that may be familiar to visitors while expediting the configuration of their catalog by eliminating the need to repeat existing information or collect new media. Visitors interacting with clickable components within this catalog would then be directed to the external content, optionally by redirecting their web browser or other application to an external page or by presenting external content within the current page. In some embodiments, this arrangement may be incentivized for users by a vendor or media provider, for example a large online marketplace may offer discounts or a portion of the proceeds from sales to users that incorporate existing media or metadata. This would encourage users to utilize existing content, while increasing traffic and sales for the provider and presenting consistent and familiar content to visitors.

### DETAILED DESCRIPTION OF EXEMPLARY EMBODIMENTS

FIG. 2 is a flow diagram illustrating an exemplary method for creating interactive metadata tags and associating with electronic multimedia, according to a preferred embodiment of the invention. According to the embodiment, a user may navigate within an administration interface 201 such as a webpage or an application interface for metadata and clickable component administration. At a top-level overview, the user may select from options 202 to create a new clickable component 203, or to open an existing component 205 for modification or use. In some embodiments, coordinates within the media for the location of the new clickable component may be provided by creation engine 113. In other embodiments, coordinates within the media for the location of the new clickable component may be provided by another graphics program or from a user device. When creating a new clickable component, the user may be prompted to import media 204 such as image or video content for use as a “canvas” upon which to overlay the clickable component for presentation to other users. In some embodiments, media and other information may be previously configured and usable by users of system (for example, a collection of images may be available for configuration with overlay clickable inheriting any preconfigured metadata provided by an owner of the image, or the product in which it represents). In some embodiments a unique identifier may be assigned to the metadata associated to the media. When editing an existing component, the user may instead be presented with the option to edit media 206 already in use, such as to edit an image or replace with other media. The user may then add or edit electronic containers 207, such as a “slideshow” container that configures content to display multiple images in an ordered or random sequence, each with their corresponding clickable components, or a “collage” container that displays multiple images at once in a predefined or random arrangement, or a “simple” container that displays a single image or video segment, or other container types. In this manner, a user may configure the visual presentation of their components and the media associated with them, by defining and configuring a container that may then be presented as a self-contained element to a content provider such as a social network or website, ensuring that their content is displayed as intended at the destination. After configuring a container, the user may select from options 208 to add visual tags as clickable components 209, or to select or modify media within the container 210a-n, such as to add more images to a collage container or to change the order of images in a slideshow, or to change a video clip in a simple video container. When adding interactive metadata tags 209, the user may configure a wide variety of attributes for the visual tag (that is the visual indicia associated to the clickable component) itself as well as the metadata associated with it, for example to configure visual styles (such as color, shape, or visually-distinct iconography to indicate the tag's content or function) or placement, and may edit behaviors associated with the tag such as to define what metadata is included (for example, adding a URL to direct a viewer to upon interaction, or to define contact information for a support or other messaging tag) or how it is to be propagated upon interaction (for example, to define which metadata attributes should be provided to a destination, or which attributes are based on the viewing or interacting user, such as the viewer's social media profile information if available). After modifying tags and media, the user may save 211 their content, and may then generate or update a presentation page 212 such as by refreshing the presented containers, components, or media within a webpage or application interface, or by providing the updated information to an external host to refresh their presentation (such as to provide clickable components to an external web hosting service).

Media utilized may be provided by the user, such as pictures or video of their own creation, or may be local or remote media selected by the user for association with interactive metadata. For example, a user may upload their own content or may choose to use existing content such as images or video segments, or they may optionally choose to link external content from another source such as an image from another website (for example, to make clickable components for overlaying on a manufacturer's product image) or a video from a hosting service such as YOUTUBE™ or VIMEO™. When using external content in this manner, content may not be modified but clickable components and containers may still be configured to utilize it. When content is saved 211 or presented 212, the media portion comprises a link or pointer to the media content on the external service, so that it may be retrieved and loaded on-demand when presented, without copying or modifying it in any way. In this manner it may be appreciated that a container serves as a transparent placeholder, with clickable components being associated with positions or other attributes of the container itself, and the media content is presented within the container in a read-only or view-only context.

Specific functions or metadata types may be utilized or configured according to a selected media or container configuration, and a user may modify the configuration and operation of their clickable components through an administration interface 201 at will. In an exemplary arrangement, a user may select a video segment for use as media content, such as a scene from a television show. When creating components, they may define various attributes such as the position of a component (to define where it is positioned when overlaid onto the media during presentation), as well as an optional duration or expiration to define when the clickable component should no longer be presented. In this manner, a clickable component may be configured to appear when a particular item or person enters the video frame, and to disappear when they leave (thus avoiding potential confusion and interface clutter). Additionally, a tag may be configured to be “dynamic” in presentation, for example once shown it may be configured to move in a specific direction or pattern, optionally with attributes such as speed or variance (for example, to configure a “moving target” component for inclusion in an advertisement scenario, or a component that appears overlaid on a person's face and follows them around as the move within a video scene). Further exemplary attributes may include dynamic appearance such as changing shape, color, or size, or changes in reaction to interaction such as clicking or hovering (for example, a tag that enlarges when a user hovers over it with their cursor, and redirects them to a new webpage when clicked, optionally propagating some or all associated metadata to the new page according to its configuration). In some embodiments, media (for example, video or other moving images) may automatically pause when a clickable component is engaged (for example, hover or click). In some embodiments, media (for example video or other moving images) may resume once the engagement of an engaged component is complete.

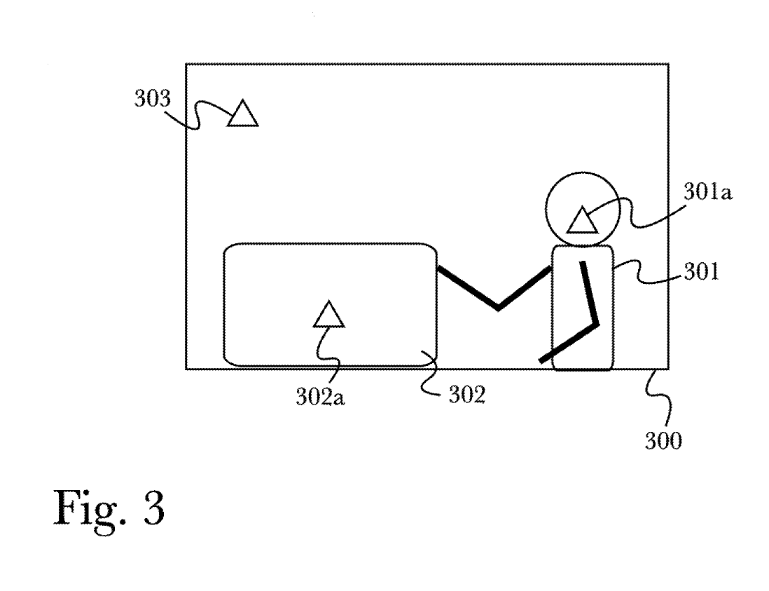

FIG. 3 is an illustration of an exemplary user interface displaying media content 300 with interactive metadata tags (embodied within clickable components) 301a, 302a, 303. As viewed by a user, for example within a webpage, software application, social networking interface, or other interface for viewing content, an image 300 may be shown with various visual content, for example, a person 301 and an object 302. When configured with clickable components comprising interactive metadata, clickable components may be overlaid upon the media when shown without necessarily modifying or accessing the media itself (for example, if the media is stored on an external service such as an image or video hosting service). For example, a clickable component 301a may be overlaid on a person 301 within an image or video frame 300 (or multiple video frames), that may present detailed information on that person when a user hovers over the component with their cursor, or may direct them to an interface to contact the person 301 when clicked (such as an email creation page, or a chat interface, or the person's 301 personal website, or other such contact means). A clickable component 302a may be overlaid on an object (item) within the media content 300, for example, to direct the user to a product information page when clicked, where they may learn more about that particular item of interest, chat with other users about the item, leave comments about the item of the media, share the item on their social network page, contact support regarding the item, or purchase the item from an online storefront. A clickable component 303 may also be overlaid on a background or “negative space” within media content 300, and may provide the user with more general information such as content creation information (who made the image, when or where was it taken, a link to a higher resolution image, etc.) or to direct them to a destination that may not be directly related to the content of the media 300, such as a company webpage for the manufacturer of the various products in the media 300, or the contact information for the webhost displaying content 300, or other general information.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

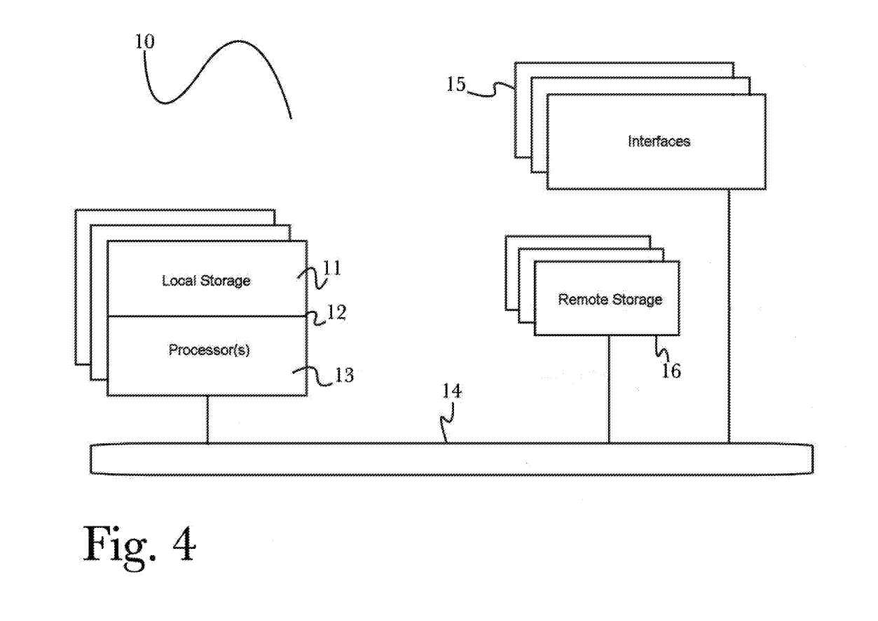

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

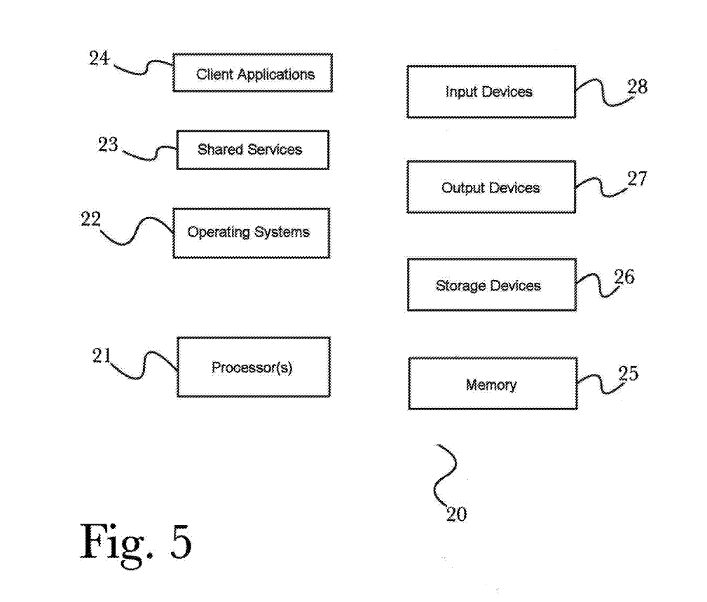

In some embodiments, systems according to the present invention may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

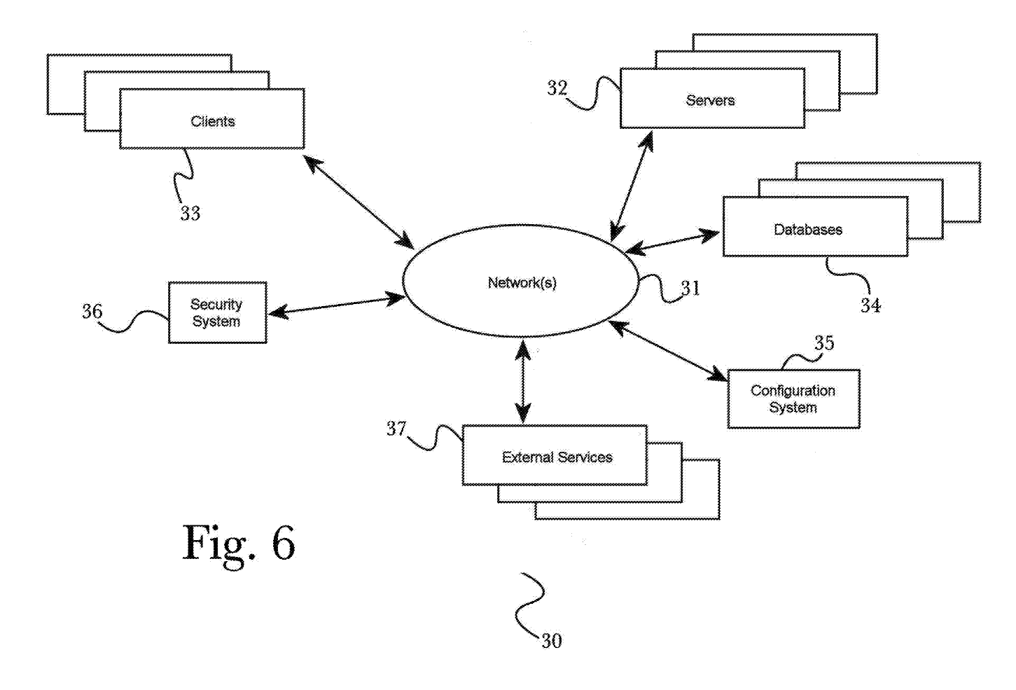

In some embodiments, systems of the present invention may be implemented on a distributed computing network, such as one having any number of clients and/or servers. Referring now to FIG. 6, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A method for creating an interactive metadata tag within media, the method comprising:
deploying a network-connected electronic interactive metadata computer comprising at least a memory and a processor and further comprising programmable instructions stored in the memory and operating on the processor, the instructions configured to assigning interactive metadata within media, comprising the steps of:
receiving, at a creation engine, an electronic image;
receiving, at the creation engine, metadata associated to the image;
receiving, at the creation engine, a request to configure a metadata tag within the image;
receiving, at the creation engine, a set of coordinates for the metadata tag, the coordinates corresponding to a location within the image;
receiving, at the creation engine, a selection of a visual tag;
receiving, at the creation engine, a plurality of attributes for the visual tag;
adding the plurality of attributes to the metadata;
assigning a unique identifier to the image and the metadata; and,
saving the unique identifier, the image and the metadata to a metadata storage database.

2. The method of claim 1, further comprising the step of receiving, at an app server, a request to engage the visual tag.

3. The method of claim 1, wherein the image corresponds to a product available for electronic purchase.

4. The method of claim 1, wherein the image corresponds to one or more sequential frames of an electronic video file.

5. The method of claim 3, wherein the metadata comprises information about the product.

6. The method of claim 5, wherein the metadata further comprises contact information associated to the product.

7. The method of claim 6, further comprising the step of receiving, at a messaging gateway, a request to contact a contact destination of the product using the contact information.

8. A method for engaging interactive metadata tags within media, the method comprising:
deploying a network-connected electronic interactive metadata computer comprising at least a memory and a processor and further comprising programmable instructions stored in the memory and operating on the processor, the instructions configured to assigning interactive metadata within media, comprising the steps of:
receiving, at a web server, a unique identifier from a user device wherein the unique identifier corresponds to an interactive metadata tag;
sending, to a metadata storage database, a request for metadata associated to unique identifier;
receiving, at the web server, the metadata associated to the unique identifier;
sending, by the web server, the metadata to the user device;
receiving, at the webserver, a request to establish communication, the request associated to the metadata;
extracting, at a messaging gateway, contact destination information from the metadata; and,
initiating communication to the destination, the communication including at least a portion of the metadata.

9. The method of claim 8, wherein the metadata corresponds to a product available for electronic purchase.

10. The method of claim 9, wherein the metadata comprises information about the product.

11. The method of claim 8, wherein the contact information is a SIP address.

12. The method of claim 8, wherein the contact information is an instant messaging address.

13. The method of claim 8, wherein the contact information is a telephone number.

14. The method of claim 10, wherein the contact information is a universal resource locator.

15. The method of claim 14, wherein the universal resource locator corresponds to a product webpage with additional information about the product.

16. The method of claim 10, wherein the contact information is a social network user account with access information.

17. The method of claim 16, wherein at least a portion of the metadata corresponding to the product is shared on the social network feed of the social network user account.

18. A system for interactive metadata and intelligent propagation for electronic multimedia, the system comprising:
a network-connected interactive metadata computer comprising at least a memory and a processor and further comprising programmable instructions stored in the memory and operating on the processor, the programmable instructions configured to interact and propagate interactive metadata, further comprising:
a creation engine for creating interactive metadata tags and clickable components utilizing interactive metadata for presentation to a plurality of network-connected user devices through visual indicia at preconfigured coordinates within media;
an account manager to manage a plurality of user device profile information for the plurality of user devices;
a web server to present interactive metadata tags and clickable components the plurality of network-connected user devices accessible via a web browser;
an app server to present interactive metadata tags and clickable components the plurality of network-connected user devices accessible via a special purpose application computer;
a messaging gateway to request communication with the plurality of network-connected user devices and a plurality of external communication services; and,
a metadata storage database to store and provide metadata content and associations.

19. The system of claim 18, wherein the media is an electronic image file.

20. The system of claim 19, wherein the media corresponds to one or more sequential frames of an electronic video file.
